(19) United States
(12) Patent Application Publication
(10) Pub. No.: US 2026/0085248 A1
(43) Pub. Date: Mar. 26, 2026

(54) CATALYSTS THAT INCLUDE ZEOLITES FOR USE IN CRACKING VACUUM GAS OIL AND RELATED METHODS

(71) Applicant: Saudi Arabian Oil Company, Dhahran (SA)

(72) Inventors: Mansour Ali Al Herz, Dammam (SA); Anaam H. Al-ShaikhAli, Al Qatif (SA); Abeer Arjah, Dhahran (SA); Yousif Al Hammadi, Al Qatif (SA); Mohammed Al Sadah, Safwa (SA)

(21) Appl. No.: 18/896,465

(22) Filed: Sep. 25, 2024

(51) Int. Cl. C10G 11/05; B01J 29/08; B01J 29/40; B01J 29/80; B01J 37/02; B01J 37/08

(52) U.S. Cl. CPC C10G 11/05; B01J 29/088; B01J 29/40; B01J 29/80; B01J 37/0201; B01J 37/0236; B01J 37/08; B01J 2229/186; B01J 2229/24; C10G 2300/1074; C10G 2300/708; C10G 2400/02; C10G 2400/20

(57) ABSTRACT

Catalysts that include a first zeolite selected from ZSM-5 and Y zeolite impregnated with P₂O₅ and a second zeolite different from the first zeolite selected from ZSM-5 and Y zeolite impregnated with La₂O₃. The catalysts can also include alumina, clay, and silica. The catalysts can be used to crack vacuum gas oil (VGO) into gasoline and butylenes. The catalysts can crack VGO with relatively good selectivity for butylenes over butanes.

### TECHNICAL FIELD

This disclosure relates to catalysts containing zeolites that can be used to crack vacuum gas oil (VGO) into gasoline and butylenes.

### BACKGROUND

Fluid catalytic cracking (FCC) can be used to produce gasoline. Operational parameters, such as cracking temperature, catalyst-to-oil ratio, residence time, reactor design, and riser-flow mode, can be optimized to improve gasoline yield and quality. Hydrocarbon feeds for fluid catalytic cracking processes can range from hydrocracked bottoms to heavy feed fractions such as vacuum gas oil and atmospheric residue. Little research has focused on converting vacuum gas oil or other hydrocarbon feeds to light olefins, particularly butylenes. It can be challenging to modify catalysts to increase butylene production and/or selectivity.

### SUMMARY

The disclosure relates to catalysts that include a first zeolite selected from ZSM-5 and Y zeolite impregnated with P₂O₅ and a second zeolite different from the first zeolite selected from ZSM-5 and Y zeolite impregnated with La₂O₃. The catalysts can also include alumina, clay, and silica. The catalysts can be used to crack VGO into gasoline and butylenes. The catalysts can crack VGO with relatively good selectivity for butylenes over butanes.

In a first aspect, the disclosure provides a method of cracking vacuum gas oil, including converting at least one component of vacuum gas oil into a product using a catalyst. The catalyst includes: a first zeolite including a member selected from the group consisting of ZSM-5 and Y zeolite and a second zeolite including a member selected from the group consisting of ZSM-5 and Y zeolite. The second zeolite is different from the first zeolite, the first zeolite is impregnated with P₂O₅, and the second zeolite is impregnated with La₂O₃.

In some embodiments, the product includes a butylene and/or gasoline.

In some embodiments, the vacuum gas oil is not hydrotreated.

In some embodiments, the converting is performed at a temperature of from 470° C. to 590° C. In some embodiments, the converting is performed at a temperature of from 470° C. to 550° C.

In some embodiments, a conversion of the vacuum gas oil is at least 80%.

In some embodiments, a yield of gasoline is at least 25%.

In some embodiments, coke production is less than 9 wt. %.

In some embodiments, a dry gas yield is less than 3 wt. %. In some embodiments, a dry gas yield is less than 2.5 wt. %.

In some embodiments, a butylene to butane ratio is at least 1.

In some embodiments, the first zeolite includes ZSM-5, and the second zeolite includes Y zeolite. In some embodiments, the first zeolite includes Y zeolite, and the second zeolite includes ZSM-5.

In some embodiments, the catalyst includes from 10 wt. % to 50 wt. % of the Y zeolite.

In some embodiments, the catalyst further includes alumina, clay, and silica.

In some embodiments, the catalyst includes: from 5 wt. % to 50 wt. % of the first zeolite, from 5 wt. % to 50 wt. % of the second zeolite, from 0.5 wt. % to 10 wt. % La₂O₃, from 0.5 wt. % to 15 wt. % P₂O₅, from 0.5 wt. % to 10 wt. % silica, from 30 wt. % to 60 wt. % clay, and from 2 wt. % to 20 wt. % alumina.

In some embodiments, the catalyst includes: 20 wt. % of ZSM-5 impregnated with P₂O₅, 21 wt. % of Y zeolite impregnated with La₂O₃, 2 wt. % silica, 49 wt. % clay, and 8 wt. % alumina.

In some embodiments, the ZSM-5 impregnated with P₂O₅ includes 7.5 wt. % P₂O₅ and the Y zeolite impregnated with La₂O₃ includes 2.5 wt. % La₂O₃.

In some embodiments, the ZSM-5 has a silica to alumina molar ratio of 5 to 80.

In some embodiments, the Y zeolite has a silica to alumina molar ratio of 5 to 80. In some embodiments, the Y zeolite has a silica to alumina molar ratio of about 5.

### DESCRIPTION OF DRAWINGS

FIG. 1 depicts a flowchart for a method of making a catalyst.

FIG. 2 depicts a graph of SimDist analysis results.

FIG. 3 depicts a schematic for a micro activity test instrument with a quartz tubular reactor.

FIG. 4A depicts a graph of conversions of prepared catalysts in the cracking of VGO.

FIG. 4B depicts a graph of light olefin distributions of prepared catalysts in the cracking of VGO.

FIG. 4C depicts a graph of gasoline yields of prepared catalysts in the cracking of VGO.

FIG. 4D depicts a graph of coke production of prepared catalysts in the cracking of VGO.

FIG. 4E depicts a graph of butylene to butane ratios of prepared catalysts in the cracking of VGO.

FIG. 5A depicts a graph of conversions for prepared catalysts and a commercial catalyst in the cracking of VGO.

FIG. 5B depicts a graph of light olefin distributions for prepared catalysts and a commercial catalyst in the cracking of VGO.

FIG. 5C depicts a graph of gasoline yields for prepared catalysts and a commercial catalyst in the cracking of VGO.

FIG. 5D depicts a graph of coke production for prepared catalysts and a commercial catalyst in the cracking of VGO.

FIG. 5E depicts a graph of butylene to butane ratios for prepared catalysts and a commercial catalyst in the cracking of VGO.

FIG. 5F depicts a graph of dry gas yields for prepared catalysts and a commercial catalyst in the cracking of VGO.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Generally, the catalysts described in the present disclosure can provide a variety of benefits when used in the cracking of VGO. As an example, the catalysts can provide relatively high conversions, relatively high yields of gasoline and/or butylenes, relatively low coke production, and/or relatively low yields of dry gas in the cracking of VGO, relative to certain other catalysts and/or cracking operations. As another example, the catalysts can have relatively high selectivity to butylenes over butanes relative to certain other catalysts and/or cracking operations. As a further example, the catalysts can increase (e.g., maximize) the yield of gasoline and/or butylenes olefins relative to certain other catalysts and/or cracking operations. In FCC units, butylenes can be used to make methyl tert-butyl ether (MTBE) which is an octane enhancer in gasoline.

Without wishing to be bound by theory, it is believed that the use of both ZSM-5 and Y zeolites provide relatively high activity and selectivity to gasoline and light olefins. It is also believed that the acidity of the Y zeolites can be optimized to offer a good tradeoff between activity (corresponding to conversion) and selectivity (see discussion below). It is further believed that the catalysts can be employed in commercial FCC units with VGO as the feedstock.

Without wishing to be bound by theory, it is believed that the Y zeolite increases (e.g., maximizes) gasoline production relative to certain other catalyst formulations and the ZSM-5 zeolite increases (e.g., maximizes) butylene production relative to certain other catalyst formulations. It is also believed that including both the Y zeolite and ZSM-5 zeolite can reduce or avoid complications related to optimizing butylenes by co-feeding separate catalysts and can make operations control easier relative to using separate catalysts.

### Definitions

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting. All publications, patent applications, patents, sequences, database entries, and other references mentioned in this document are incorporated by reference in their entirety. In case of conflict, the present specification, including definitions, will control.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to 5%” should be interpreted to include not just 0.1% to 5%, but also the individual values (for example, 1%, 2%, 3%, and 4%) and the sub-ranges (for example, 0.1% to 0.5%, 1.1% to 2.2%, and 3.3% to 4.4%) within the indicated range.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used herein, the term “catalyst” generally refers to the active catalyst portion of a catalyst material. The catalyst is generally processed in further steps to form a catalyst material. The catalyst material may also be processed in further steps to form a final catalyst material.

### Catalysts

A catalyst of the disclosure includes a first zeolite selected from ZSM-5 and Y zeolite impregnated with P₂O₅, and a second zeolite different from the first zeolite selected from ZSM-5 and Y zeolite impregnated with La₂O₃. The catalyst also includes alumina, clay, and silica.

Without wishing to be bound by theory, it is believed that the Y zeolite establishes the activity of the catalyst (feed conversion) and cracks larger hydrocarbons into smaller hydrocarbons. This is due to the relatively large pores of the Y zeolite which facilitate the diffusion of larger molecules. Further, the silica to alumina ratio in a zeolite relates to the acidity of the zeolite, with a lower silica-to-alumina ratio indicating higher acidity as aluminum atoms control the acidity. The catalytic cracking is believed to occur at these acidic sites. Therefore, feed conversion is expected to increase proportionally with the density of the acidic sites. It is also believed that the acidic sites density significantly impacts the feedstock conversion and product selectivity.

Without wishing to be bound by theory, it is believed that the ZSM-5 establishes the selectivity to light olefins such as butylenes, cracks relatively light hydrocarbons (C₆-C₉ olefins) selectively to butylenes and gasoline, and is a gasoline octane improver as ZSM-5 increases the selectivity of olefinic molecules and thus the octane number. The silica to alumina ratio (acidity) of ZSM-5 has an influence on the selectivity. The acidity is selected to increase the conversion to light olefins without facilitating hydrogen transfer which saturates the formed olefins into their relevant alkanes.

Without wishing to be bound by theory, it is believed that the La₂O₃ improves the hydrothermal stability of the zeolite it is impregnated in, promotes the cracking activity, and sequesters vanadium in the feed and prevents it deleterious effects.

Without wishing to be bound by theory, it is believed that the P₂O₅ stabilizes the structure of the zeolitic framework it is impregnated in by reducing (e.g., preventing) the segregation of the framework alumina and thus improving the hydrothermal stability of the zeolite.

Without wishing to be bound by theory, it is believed that the alumina binds the catalyst components to improve attrition resistance and establishes pre-cracking of feed hydrocarbons. The relatively wide pores (mesopores and macropores) of the alumina are believed to crack larger molecules in the feedstock.

Without wishing to be bound by theory, it is believed that the clay provides physical strength to the catalyst, controls the catalyst's density, improves attrition resistance, and improves resistance to feed poisons. Additionally, without wishing to be bound by theory, it is believed that the clay can improve the heat capacity of the catalyst. For heat balance, the reaction-regeneration cycle can be considered as a closed-loop. The regenerator is the heating medium, and the reactor is the cooling medium (since the reaction is endothermic). Coke combustion in the regenerator supplies the heat to evaporate the feed and conduct the cracking reaction.

Without wishing to be bound by theory, it is believed that the silica acts as a binder and filler to provide additional physical strength to the catalyst, improves attrition resistance of the catalyst and stabilizes the activity of the catalyst.

In some embodiments of the catalyst of the present disclosure, the first zeolite includes ZSM-5 and the second zeolite includes Y zeolite. Thus, in such embodiments, the catalyst includes ZSM-5 impregnated with P₂O₅ and Y zeolite impregnated with La₂O₃. In some embodiments, the first zeolite includes Y zeolite and the second zeolite includes ZSM-5. Hence, in such embodiments, the catalyst includes Y zeolite impregnated with P₂O₅ and ZSM-5 impregnated with La₂O₃.

Without wishing to be bound by theory, it is believed that the acidities of ZSM-5 and Y zeolite offer high activity and selectivity to light olefins and/or gasoline. In some embodiments, the acidity (silica to alumina) ratio of the Y zeolite and/or the ZSM-5 is tuned to alter the activity and/or selectivity of the catalyst.

In some embodiments, the Y zeolite is USY zeolite (ultra stable Y zeolite). USY can be produced by subjecting the Y zeolite to hydrothermal treatment. Without wishing to be bound by theory, it is believed that the hydrothermal treatment causes dealumination.

In some embodiments, in addition to ZSM-5 and Y zeolite, the catalyst includes mordenite, beta zeolite, and/or ferrierite.

In certain embodiments, the ZSM-5 has a silica to alumina molar ratio of at least 5 (e.g., at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, at least 100, at least 110, at least 120, at least 130, at least 140, at least 150, at least 160, at least 170, at least 180, at least 190, at least 200, at least 210, at least 220, at least 230, at least 240, at least 250, at least 260, or at least 270) and/or at most 280 (e.g., at most 270, at most 260, at most 250, at most 240, at most 230, at most 220, at most 210, at most 200, at most 190, at most 180, at most 170, at most 160, at most 150, at most 140, at most 130, at most 120, at most 110, at most 100, at most 95, at most 90, at most 85, at most 80, at most 75, at most 70, at most 65, at most 60, at most 55, at most 50, at most 45, at most 40, at most 35, at most 30, at most 25, at most at most 15, or at most 10). In certain embodiments, the ZSM-5 has a silica to alumina molar ratio of about 30.

In certain embodiments, the ZSM-5 has a surface area of at least 200 m²/g (e.g., at least 250, at least 300, at least 350, at least 400, at least 450, at least 500, at least 550, at least 600, at least 650, at least 700, or at least 750 m²/g) and/or at most 800 m²/g (e.g., at most 750, at most 700, at most 650, at most 600, at most 550, at most 500, at most 450, at most 400, at most 350, at most 300, or at most 250 m²/g). In certain embodiments, the ZSM-5 has a surface area of about 405 m²/g.

In certain embodiments, the ZSM-5 zeolite has an average total pore volume per unit weight of at least 0.01 milliliters per gram (mL/g) (e.g., at least 0.02, at least 0.03, at least 0.04, at least 0.05, at least 0.06, at least 0.07, at least 0.08, at least 0.09, at least 0.1, at least 0.15, at least 0.2, at least 0.25, at least 0.3, at least 0.35, at least 0.4, or at least 0.45 mL/g) and/or at most 0.5 mL/g (e.g., at most 0.45, at most 0.4, at most 0.35, at most 0.3, at most 0.25, at most 0.2, at most 0.15, at most 0.1, at most 0.09, at most 0.08, at most 0.07, at most 0.06, at most 0.05, at most 0.04, at most 0.03, or at most 0.02 mL/g).

In certain embodiments, the Y zeolite has a silica to alumina molar ratio of at least 5 (e.g., at least 5.2, at least 10, at least 15, at least 20, at least 25, at least 30, at least 35, at least 40, at least 45, at least 50, at least 55, at least 60, at least 65, at least 70, or at least 75) and/or at most 80 (e.g., at most 75, at most 70, at most 65, at most 60, at most 55, at most 50, at most 45, at most 40, at most 35, at most 30, at most 25, at most 20 at most 15, at most 10, or at most 5.2). In certain embodiments, the Y zeolite has a silica to alumina molar ratio of 5.2, 12, 30, 60, or 80. In certain embodiments, the Y zeolite has a silica to alumina molar ratio of about 5. In certain embodiments, the Y zeolite has a silica to alumina molar ratio of about 5.2. In certain embodiments, the Y zeolite has a silica to alumina molar ratio of about 12. In certain embodiments, the Y zeolite has a silica to alumina molar ratio of about 30. In certain embodiments, the Y zeolite has a silica to alumina molar ratio of about 60. In certain embodiments, the Y zeolite has a silica to alumina molar ratio of about 80.

In certain embodiments, the Y zeolite has a surface area of at least 200 m²/g (e.g., at least 250, at least 300, at least 350, at least 400, at least 450, at least 500, at least 550, at least 600, at least 650, at least 700, or at least 750 m²/g) and/or at most 800 m²/g (e.g., at most 750, at most 700, at most 650, at most 600, at most 550, at most 500, at most 450, at most 400, at most 350, at most 300, or at most 250 m²/g). In certain embodiments, the Y zeolite has a surface area of about 780 m²/g. Without wishing to be bound by theory, it is believed that the surface area for the Y zeolite can vary for different silica to alumina molar ratios.

In certain embodiments, the ZSM-5 and/or Y zeolite exhibit one or more of the properties listed in Table 1.

TABLE 1
Zeolite properties

| | SiO₂/Al₂O₃ | Nominal | | Unit | Surface |
|---|---|---|---|---|---|
| | Mole | Cation | Na₂O | Cell | Area, |
| | Ratio | Form | Weight % | Size, Å | m²/g |
| ZSM-5 | 30 | Ammonium | 0.05 | | 405 |
| Y zeolite | 5.2, 12, 30, | Hydrogen | 0.03 | 24.24 | 780 |
| | 60, or 80 | | | | |

In some embodiments, the catalyst includes at least 5 wt. % (e.g., at least 10, at least 15, at least 20, at least 25, at least 30, at least 35, at least 40, or at least 45 wt. %) and/or at most 50 wt. % (e.g., at most 45, at most 40, at most 35, at most 30, at most 25, at most 20, at most 15, or at most 10 wt. %) of the first zeolite. In some embodiments, the catalyst includes about 20 wt. % of the first zeolite. In such embodiments, the first zeolite is ZSM-5 or Y zeolite.

In some embodiments, the catalyst includes at least 5 wt. % (e.g., at least 10, at least 15, at least 20, at least 25, at least 30, at least 35, at least 40, or at least 45 wt. %) and/or at most 50 wt. % (e.g., at most 45, at most 40, at most 35, at most 30, at most 25, at most 20, at most 15, or at most 10 wt. %) of the second zeolite. In some embodiments, the catalyst includes about 20 wt. % of the second zeolite. In some embodiments, the catalyst includes about 21 wt. % of the second zeolite. In such embodiments, the second zeolite is ZSM-5 or Y zeolite, providing that the first zeolite is different from the second zeolite. In other words, if the first zeolite is ZSM-5, then the second zeolite is Y zeolite, and, if the first zeolite is Y zeolite, then the second zeolite is ZSM-5.

In some embodiments, the total amount of ZSM-5 and Y zeolite in the catalyst is at least about 10 wt. % (e.g., at least about 15, at least about 20, at least about 25, at least about 30, at least about 35, at least about 40, or at least about 45 wt. %) and/or at most about 50 wt. % (e.g., at most about 45, at most about 40, at most about 35, at most about 30, at most about 25, at most about 20, or at most about 15 wt. %).

In certain embodiments, the catalyst includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, at least 9.5, at least 10, at least 10.5, at least 11, at least 11.5, at least 12, at least 12.5, at least 13, at least 13.5, at least 14, or at least 14.5 wt. %) and/or at most 15 wt. % (e.g., at most 14.5, at most 14, at most 13.5, at most 13, at most 12.5, at most 12, at most 11.5, at most 11, at most 10.5, at most 10, at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) P₂O₅.

In certain embodiments, the first zeolite includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, at least 9.5, at least 10, at least 10.5, at least 11, at least 11.5, at least 12, at least 12.5, at least 13, at least 13.5, at least 14, or at least 14.5 wt. %) and/or at most 15 wt. % (e.g., at most 14.5, at most 14, at most 13.5, at most 13, at most 12.5, at most 12, at most 11.5, at most 11, at most 10.5, at most 10, at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) of P₂O₅. In certain embodiments, the first zeolite includes about 7.5 wt. % P₂O₅.

In certain embodiments, the catalyst includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, or at least 9.5 wt. %) and/or at most 10 wt. % (e.g., at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) La₂O₃. In certain embodiments, the second zeolite includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, or at least 9.5 wt. %) and/or at most 10 wt. % (e.g., at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) La₂O₃. In certain embodiments, the second zeolite includes about 2.5 wt. % La₂O₃.

In general, the silica can be in one or more of a variety of appropriate forms. As an example, in some embodiments, the silica includes colloidal silica. In some embodiments, the catalyst includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, or at least 9.5 wt. %) and/or at most 10 wt. % (e.g., at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) silica. In some embodiments, the catalyst includes about 2 wt. % silica. In some embodiments, the silica has a molecular weight of 60.08 g/mol. In some embodiments, the silica has a relative density of 1.3 g/ml.

Generally, the clay can be in one or more of a variety of appropriate forms. As an example, in certain embodiments, the clay includes kaolin and/or montmorillonite. In certain embodiments, the catalyst includes at least 30 wt. % (e.g., at least 35, at least 40, at least 45, at least 50, or at least 55 wt. %) and/or at most 60 wt. % (e.g., at most 55, at most 50, at most 45, at most 40, or at most 35 wt. %) clay. In certain embodiments, the catalyst includes about 49 wt. % clay. In certain embodiments, the clay has a specific gravity of 2.2. In certain embodiments, the clay has a molecular weight of 258.2 g/mol. In certain embodiments, the clay has a melting point of 1760° C.

In some embodiments, the catalyst includes at least 2 wt. % (e.g., at least 4, at least 6, at least 8, at least 10, at least 12, at least 14, at least 16, or at least 18 wt. %) and/or at most 20 wt. % (e.g., at most 18, at most 16, at most 14, at most 12, at most 10, at most 8, at most 6, or at most 4 wt. %) alumina. In some embodiments, the catalyst includes about 8 wt. % alumina. In some embodiments, the alumina has a density of at least 2.8 g/cm³ (e.g., at least 2.9 g/cm³) and/or at most 3 g/cm³ (e.g., at most 2.9 g/cm³). In some embodiments, the alumina has a loose bulk density of 670-750 g/L. In some embodiments, the alumina has a packed bulk density of 800-1100 g/L. In some embodiments, the alumina has a particle size (d₅₀) of 60 μm. In some embodiments, the alumina has a surface area (BET) of 0.50 ml/g after activation at 350° C. for 3 hours. In some embodiments, the alumina has a pore volume of 0.50 ml/g after activation at 350° C. for 3 hours. In some embodiments, the alumina has a crystallite size (12) of 4.5 nm.

In certain embodiments, the catalyst can have a crystallinity of at least 10% (e.g., at least 15, at least 20, at least 25, at least 30, at least 35, at least 40, at least 45, at least 50, at least 55, at least 60, at least 65, at least 70, at least 75, at least 80, at least 85, at least 90, or at least 95%) and/or at most 100% (e.g., at least 95, at least 90, at least 85, at least 80, at least 75, at least 70, at least 65, at least 60, at least 55, at least 50, at least 45, at least 40, at least 35, at least 30, at least 25, at least 20, or at least 15%). In certain embodiments, the catalysts have a crystallinity of about 22%. Without wishing to be bound by theory, it is believed the crystallinity is typically associated with the zeolites. In certain embodiments, the catalyst can have an attrition index of at least 3% (e.g., at least 4, at least 5, at least 6, at least 7, at least 8, at least 9, at least 10, at least 11, at least 12, at least 13, or at least 14%) and/or at most 15% (e.g., at most 14, at most 13, at most 12, at most 11, at most 10, at most 9, at most 8, at most 7, at most 6, at most 5, or at most 4%). In certain embodiments, the catalysts have an attrition index of about 4%. In certain embodiments, the catalyst can have a crystallinity of at least 200 m²/g (e.g., at least 250, at least 300, at least 350, at least 400, at least 450, at least 500, at least 550, at least 600, at least 650, at least 700, or at least 750 m²/g) and/or at most 800 m²/g (e.g., at most 750, at most 700, at most 650, at most 600, at most 550, at most 500, at most 450, at most 400, at most 350, at most 300, or at most 250 m²/g). In certain embodiments, the catalyst can have an average particle size of at least 40 μm (e.g., at least 50, at least 60, at least 70, at least 80, at least 90, at least 100, or at least 110 μm) and/or at most 120 μm (e.g., at most 110, at most 100, at most 90, at most 80, at most 70, at most 60, or at most 50 μm).

In some embodiments, the catalysts fulfill the standard specifications for fluid catalytic cracking processes, including relatively high activity, relatively high selectivity to light olefins and/or gasoline, proper active site density, regenerability, stability, mechanical stability and attrition loss resistance, heat capacity for heat transfer and particle size distribution. In some embodiments, the relatively high activity is provided by the relatively large pores of the Y zeolite, the relatively high acidity of the Y zeolite, and the relatively large surface area of the Y zeolite. In some embodiments, the relatively high selectivity to light olefins is provided by the ZSM-5 zeolite which has a smaller pore size relative to the Y zeolite. In some embodiments, the proper active site density is governed by the acidities of ZSM-5 and Y zeolites. In some embodiments, the produced coke from the reactions can be combusted in the regenerator without exceeding the ceiling temperature of the regenerator, thereby providing regenerability. In some embodiments, the catalysts have relatively good stability as the catalysts can withstand relatively high process temperatures and steam exposure (e.g., the catalyst can withstand steam deactivation at 810° C. for 6 hours). In some embodiments, the filler (e.g., kaoline clay) and binder (e.g., silica and alumina) of the catalyst provide mechanical stability and attrition loss resistance. In some embodiments, the clay provides heat capacity for heat transfer. In some embodiments, the particle size range of the catalyst (40-120 μm) provides a good density for fluidization.

In some embodiments, the heat generated from burning coke on the catalyst is the heat needed for evaporating the feed and conducing the cracking reactions.

In some embodiments, the catalyst is a catalyst as described in U.S. patent application Ser. No. 18/502,353, which is incorporated by reference herein in its entirety.

### Methods of Making Catalysts

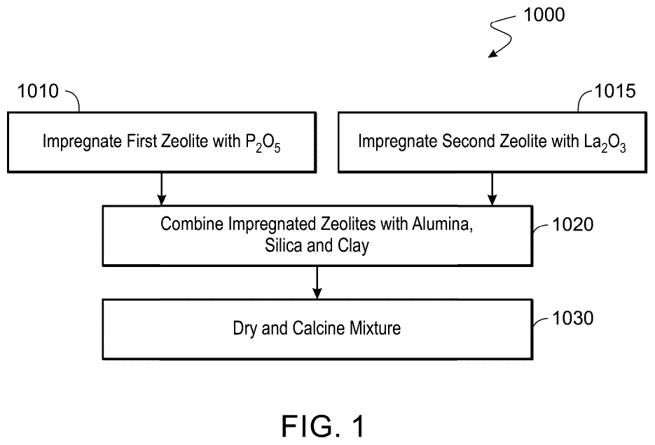

FIG. 1 shows a flowchart for a method 1000 of making a catalyst.

In step 1010, the first zeolite is impregnated with P₂O₅. Impregnation with P₂O₅ can include combining the first zeolite with a phosphorus-containing compound, such as di-ammonium hydrogen phosphate ((NH₄)₂PO₄), and drying, followed by calcining the mixture. In some embodiments, the first zeolite is impregnated with at least 1 wt. % (e.g., at least 2, at least 3, at least 4, at least 5, at least 6, at least 7, at least 8, at least 9, at least 10, at least 11, at least 12, at least 13, at least 14, at least 15, at least 16, at least 17, at least 18, or at least 19 wt. %) and/or at most 20 wt. % (e.g., at most 19, at most 18, at most 17, at most 16, at most 15, at most 14, at most 13, at most 12, at most 11, at most 10, at most 9, at most 8, at most 7, at most 6, at most 5, at most 4, at most 3, or at most 2 wt. %) phosphorous pentoxide. In some embodiments, the first zeolite is impregnated with about 7.5 wt. % phosphorous pentoxide.

In step 1015, the second zeolite is impregnated with La₂O₃. Impregnation with La₂O₃ can include combining the second zeolite with a lanthanum-containing compound, such as lanthanum nitrate (III) hydrate, and drying, followed by calcining the mixture. In some embodiments, the second zeolite is impregnated with at least 1 wt. % (e.g., at least 2, at least 3, or at least 4 wt. %) and/or at most 5 wt. % (e.g., at most 4, at most 3, or at most 2 wt. %) lanthanum oxide. In some embodiments, the second zeolite is impregnated with about 2.5 wt. % lanthanum oxide.

In some embodiments, the mixture in the step 1010 and/or 1015 is dried at a temperature of at least 120° C. (e.g., at least 150, at least 200, at least 250, at least 300, at least 350, at least 400, or at least 450° C.) and/or at most 500° C. (e.g., at most 450, at most 400, at most 350, at most 300, at most 250, at most 200, or at most 150° C.). In some embodiments, the mixture in the step 1010 and/or 1015 is dried for at least 1 hour (e.g., at least 2, at least 3, at least 4, at least 5, at least 6, at least 7, at least 8, at least 9, at least 10, or at least 11 hours) and/or at most 12 hours (e.g., at most 11, at most 10, at most 9, at most 8, at most 7, at most 6, at most 5, at most 4, at most 3, or at most 2 hours). In some embodiments, the mixture in the step 1010 and/or 1015 is dried at about 120° C. for about 12 hours. In some embodiments, the mixture in the step 1010 and/or 1015 is calcined at a temperature of at least 400° C. (e.g., at least 450, at least 500, at least 550, at least 600, or at least 650° C.) and/or at most 700° C. (e.g., at least 650, at least 600, at least 550, at least 500, or at least 450° C.). In some embodiments, the mixture in the step 1010 and/or 1015 is calcined for at least 15 hours (e.g., at least 16, at least 17, at least 18, at least 19, at least 20, at least 21, at least 22, or at least 23 hours) and/or at most 24 hours (e.g., at most 23, at most 22, at most 21, at most 20, at most 19, at most 18, at most 17, or at most 16 hours). In some embodiments, the mixture in the step 1010 and/or 1015 is calcined at about 500° C. for about 1 hour.

In step 1020, the impregnated zeolites are mixed with alumina, silica (e.g., colloidal silica), and clay. In certain embodiments, the mixture in the step 1020 includes at least 5 wt. % (e.g., at least 10, at least 15, at least 20, at least 25, at least 30, at least 35, at least 40, or at least 45 wt. %) and/or at most 50 wt. % (e.g., at most 45, at most 40, at most 35, at most 30, at most 25, at most 20, at most 15, or at most 10 wt. %) of the first zeolite. In certain embodiments, the mixture in the step 1020 includes about 20 wt. % of the first zeolite. In certain embodiments, the mixture in the step 1020 includes at least 5 wt. % (e.g., at least 10, at least 15, at least 20, at least 25, at least 30, at least 35, at least 40, or at least 45 wt. %) and/or at most 50 wt. % (e.g., at most 45, at most 40, at most 35, at most 30, at most 25, at most 20, at most 15, or at most 10 wt. %) of the second zeolite. In certain embodiments, the mixture in the step 1020 includes about 21 wt. % of the second zeolite. In certain embodiments, the mixture in the step 1020 includes at least 0.5 wt. % (e.g., at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, or at least 9.5 wt. %) and/or at most 10 wt. % (e.g., at most 9.5, at most 9, at most 8.5, at most 8, at most 7.5, at most 7, at most 6.5, at most 6, at most 5.5, at most 5, at most 4.5, at most 4, at most 3.5, at most 3, at most 2.5, at most 2, at most 1.5, or at most 1 wt. %) colloidal silica. In certain embodiments, the mixture in the step 1020 includes about 2 wt. % colloidal silica. In certain embodiments, the mixture in the step 1020 includes at least 30 wt. % (e.g., at least 35, at least 40, at least 45, at least 50, or at least 55 wt. %) and/or at most 60 wt. % (e.g., at most 55, at most 50, at most 45, at most 40, or at most 35 wt. %) clay. In certain embodiments, the mixture in the step 1020 includes 49 wt. % clay. In certain embodiments, the mixture in the step 1020 includes at least 2 wt. % (e.g., at least 4, at least 6, at least 8, at least 10, at least 12, at least 14, at least 16, or at least 18 wt. %) and/or at most 20 wt. % (e.g., at most 18, at most 16, at most 14, at most 12, at most 10, at most 8, at most 6, or at most 4 wt. %) alumina. In certain embodiments, the mixture in the step 1020 includes about 8 wt. % alumina.

In step 1030, the resulting mixture is dried then calcined. In some embodiments, the mixture is dried at a temperature of at least 120° C. (e.g., at least 150, at least 200, at least 250, at least 300, at least 350, at least 400, or at least 450° C.) and/or at most 500° C. (e.g., at most 450, at most 400, at most 350, at most 300, at most 250, at most 200, or at most 150° C.). In some embodiments, the mixture is dried for at least 1 hour (e.g., at least 2, at least 3, at least 4, at least 5, at least 6, at least 7, at least 8, at least 9, at least 10, or at least 11 hours) and/or at most 12 hours (e.g., at most 11, at most 10, at most 9, at most 8, at most 7, at most 6, at most 5, at most 4, at most 3, or at most 2 hours). In some embodiments, the mixture is calcined at a temperature of at least 400° C. (e.g., at least 450, at least 500, at least 550, at least 600, or at least 650° C.) and/or at most 700° C. (e.g., at least 650, at least 600, at least 550, at least 500, or at least 450° C.). In some embodiments, the mixture is calcined for at least 15 hours (e.g., at least 16, at least 17, at least 18, at least 19, at least 20, at least 21, at least 22, or at least 23 hours) and/or at most 24 hours (e.g., at most 23, at most 22, at most 21, at most 20, at most 19, at most 18, at most 17, or at most 16 hours).

In general, the acidity of a zeolite is defined as the silica-to-alumina ratio (SAR). The acidity of the Y zeolite and/or ZSM-5 in the catalyst can be varied by using zeolites with varying SARs.

### Methods of Using Catalysts

The catalysts can be used to crack VGO into gasoline and butylenes. The catalysts can crack VGO with relatively good selectivity for butylene over butanes. Without wishing to be bound by theory, it is believed that the catalyst has a reasonable production of coke.

In some embodiments, the VGO is not hydrotreated. In general, hydrotreatment of VGO removes feedstock contaminants and changes the hydrocarbons composition but can be very costly. Thus, the use of VGO that is not hydrotreated can result in significant economic benefits. In some embodiments the feedstock to be cracked significantly impacts the products. Therefore, hydrotreating the VGO may result in different conversions, yields, and/or selectivities of the products.

In general, the cracking of VGO can be performed under lower severity reaction conditions in the form of lower temperature relative to certain other cracking processes. For example, in some embodiments, the cracking of VGO can be performed at a temperature of at least 470° C. (e.g., at least 480, at least 490, at least 500, at least 510, at least 520, at least 530, at least 540, at least 550, at least 560, at least 570, or at least 580° C.) and/or at most 590° C. (e.g., at most 580, at most 570, at most 560, at most 550, at most 540, at most 530, at most 520, at most 510, at most 500, at most 490, or at most 480° C.). Without wishing to be bound by theory, it is believed that the cracking temperature plays a role in the selectivity to different cracking to products. Lower cracking temperatures favor the production of gasoline while higher cracking temperatures favor the production of light olefins.

As used herein, the conversion is calculated as:

$$Conversion = 100 - LCO - HCO$$

where LCO is light cycle oil, which has a boiling range of 221-343° C., and HCO is heavy cycle oil, which has a boiling range of >343° C. It is assumed that that everything output that was not LCO or HCO was a product of the reaction. In some embodiments, in the cracking of VGO, the catalysts has a conversion of at least 70% (e.g., at least 75, at least 80, or at least 85%) and/or at most 90% (e.g., at most 85, at most 80, or at most 75%) at a temperature of 530° C. and a catalyst-to-oil ratio of 7.

As used herein, the yield is calculated as:

$$Yield = weight of product / weight of feed$$

In some embodiments, in the cracking of VGO, the catalysts have a yield of butylenes of at least 8 wt. % (e.g., at least 9, at least 10, at least 11, at least 12, at least 13, or at least 14 wt. %) and/or at most 15 wt. % (e.g., at most 14, at most 13, at most 12, at most 11, at most 10, or at most 9 wt. %) at a temperature of 530° C. and a catalyst-to-oil ratio of 7. In some embodiments, in the cracking of gasoline the catalysts have a yield of gasoline of at least 25 wt. % (e.g., at least 26, at least 27, at least 28, at least 29, at least 30, at least 31, at least 32, at least 33, at least 34, at least 35, at least 36, at least 37, at least 38, or at least 39 wt. %) and/or at most 40 wt. % (e.g., at most 39, at most 38, at most 37, at most 36, at most 35, at most 34, at most 33, at most 32, at most 31, at most 30, at most 29, at most 28, at most 27, or at most 26 wt. %) at a temperature of 530° C. and a catalyst-to-oil ratio of 7. In some embodiments, increasing the temperature and/or catalyst-to-oil ratio increases the conversion. However, increasing the conversion of light olefines may be at the expense of gasoline.

As used here, the coke production is calculated by burning the coke and measuring the amount of carbon dioxide produced. In some embodiments, the cracking of VGO, the catalysts have a coke production of at least 3 wt. % (e.g., at least 4, at least 5, at least 6, at least 7, at least 8, or at least 9 wt. %) and/or at most 10 wt. % (e.g., at most 9, at most 8, at most 7, at most 6, at most 5, or at most 4 wt. %) a temperature of 530° C. and a catalyst-to-oil ratio of 7.

As used herein, the butylene to butane ratio is calculated as the sum of all butylene products produced (trans-2-butene, cis-2-butene, 1-butene, iso-butene, and 1,3-butadiene) divided by the sum of all butane products produced (isobutane and n-butane). In some embodiments, in the cracking of VGO, the catalysts have a butylene to butane ratio of at least 1 (e.g., at least 1.1, at least 1.2, at least 1.3, at least 1.4, at least 1.5, at least 1.6, at least 1.7, at least 1.8, or at least 1.9) and/or at most 2 (e.g., at most 1.9, at most 1.8, at most 1.7, at most 1.6, at most 1.5, at most 1.4, at most 1.3, at most 1.2, at most 1.1).

### EXAMPLES

### Materials

TABLE 2
Materials and specifications

| | Part Number and | | | |
|---|---|---|---|---|
| Material | Supplier | Specifications | | |
| ZSM-5 | CBV 3024E - Zeolyst | SiO₂/Al₂O₃, molar | 30 | |
| | International | ratio | | |
| | | Nominal Cation | Ammonium | |
| | | Form | | |
| | | Na₂O Weight | 0.05% | |
| | | Surface area, m²/g | 425 | |
| Y zeolite | CBV 780 - Zeolyst | SiO₂/Al₂O₃, molar | 80 | |
| | International | ratio | | |
| | | Nominal Cation | Hydrogen | |
| | | Form | | |
| | | Na₂O Weight | 0.03% | |
| | | Unit Cell Size, A | 24.24 | |
| | | Surface area, | 780 | |
| | | m²/gm | | |
| | | Crystallinity, % | ≥95 | |
| | | Density, gm/mL at | 1.22 | |
| | | 25° C. | | |
| Kaolin Clay | Petrobras | Appearance | White | |
| | | | powder | |
| | | Specific gravity | 2.2 | |
| | | Molecular weight | 258.2 | g/mole |
| | | Melting Point | 1760° | C. |
| Alumina | CATAPAL A | Density | 2.8-3 | g/cm³ |
| | Alumina - Sasol | | | |
| Diammonium hydrogen | Sigma Aldrich | Molecular weight | 132.06 | g/mol |
| phosphate | | Relative density | 1.620 | g/cm³ |
| Lanthanum(III) nitrate | Sigma Aldrich | Molecular weight | 433.01 | g/mol |
| hexahydrate | | | | |
| Colloidal silica | Ludox TM-40 - | Molecular weight | 60.08 | g/mol |
| | Sigma Aldrich | Relative density | 1.3 | g/ml |
| Formic acid | Sigma Aldrich | | | |

The parameters were taken directly from the relevant manufacturer which did not clearly provide any ASTM methods or protocols.

### Synthetic Procedure

ZSM-5 was impregnated with phosphorus to provide 7.5 wt. % P₂O₅ on the zeolite. 14 g (NH₄)₂PO₄ was dissolved in demetallized water. 114 g ZSM-5 was dispersed in demetallized water and was added to the (NH₄)₂PO₄ under wet milling and the resulting mixture was stirred for about 1 hour. The slurry was oven dried at 120° C. for 12 hours followed by calcination at 500° C. for 1 hour and finally cooled to room temperature. Without wishing to be bound by theory, it is believed that the (NH₄)₂PO₄ decomposes into P₂O₅. The calculation of 7.5 wt. % P₂O₅ was based on the decomposition of (NH₄)₂PO₄ into P₂O₅.

Y zeolite was impregnated with lanthanum to provide 2.5 wt. % La₂O₃ on the zeolite. 7 g lanthanum nitrate (III) hydrate, (99.9% metal basis) was dissolved in demetallized water. Under wet milling, 116 g USY zeolite dispersed in demetallized water was added to the lanthanum nitrate (III) hydrate and the resulting mixture was stirred for around 1 hour. The slurry was oven dried at 120° C. for 12 hours followed by calcination at 500° C. for 1 hour and cooled to room temperature.

The alumina was treated with formic acid to produce alumina sol with particle sizes in the range of several hundred nanometers.

The impregnated zeolites were mixed with the treated alumina, silica and clay in the amounts provided in Table 3 in de-metalized water and the resulting mixture was stirred for 1 hour. The obtained slurry was sieved to remove large particles to avoid blockages during spray drying. The spray dryer temperature was set at 300° C. and the feed inlet temperature was set at 110° C. Atomization air was set at 0.125 bar. The spray drying stage was commenced to produce spherical particles within a particle size range suitable for fluidization (40-120 μm). The spray dried catalyst was then placed in temperature programmed oven for drying and calcination at the following program (rate (° C./min): Temperature (° C.): time (hours)): 7:125:7→3:200:1→2:320:1→2:440:7→1:550:1→7:100:1. The catalyst was then ground to fine powder using a mortar and a pestle. Finally, the grounded catalyst was sieved for a fraction between 40-120 microns. The attrition index was measured to be about 4%. The density was measured to be about 0.9352 g/cm³.

TABLE 3
Amounts of catalyst precursors

| Component | Weight % | Notes |
|---|---|---|
| ZSM-5 | 20 | Phosphorous impregnated at |
| | | 7.5 wt. % P₂O₅ on zeolite |
| USY | 21 | Lanthanum impregnated at |
| | | 2.5 wt. % La₂O₃ on zeolite |
| Alumina | 8 | Pural SB from Sasol |
| Clay | 49 | Kaolin |
| Silica | 2 | Added as colloidal silica Ludox TM-40 |

The procured feedstock was characterized in-house to synthesize tailored catalyst formulations for efficient conversion and selectivity to the targeted products. Table 4 shows that the amounts of trace contaminants (Fe, Ni, Na and V) in the feedstock are sufficiently low that they will not lead to catalytic deactivation and/or reduced conversion rates of the synthesized catalysts when deployed in the FCC unit.

TABLE 4
Elemental Feed Analyses

| | ASTM | | |
|---|---|---|---|
| Nitrogen | D-4629 | 1163.2 | ppm |
| S | D-4294 | 3.26 | wt. % |
| Fe | D-5708 | <1 | ppm |
| Ni | D-5708 | <1 | ppm |
| Na | D-1067 | <1 | ppm |
| V | D-5708 | <1 | ppm |

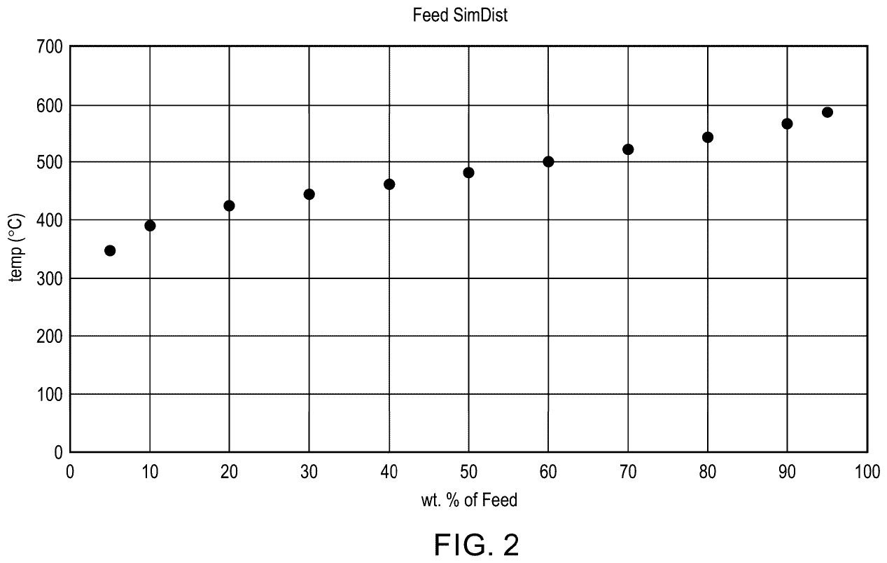

A SimDist analysis of the feed was performed following ASTM D-7169 and the results are presented in FIG. 2, which shows an initial boiling point of 348° C. and a complete recovery at about 600° C. This provides an indication as to what weight of the feed will be evaporated upon contact with the regenerated hot catalyst. FIG. 2 shows that for reactions conducted at 530° C. (see below), around 70 wt. % of the feed is evaporated. This would mean that 70% of the reactions are in the gas phase while 30% will be in the liquid phase. Without wishing to be bound by theory, it is believed that gas phase reactions favor the production of light olefins while liquid phase reactions increase the production of coke.

### Catalytic Cracking Experiments

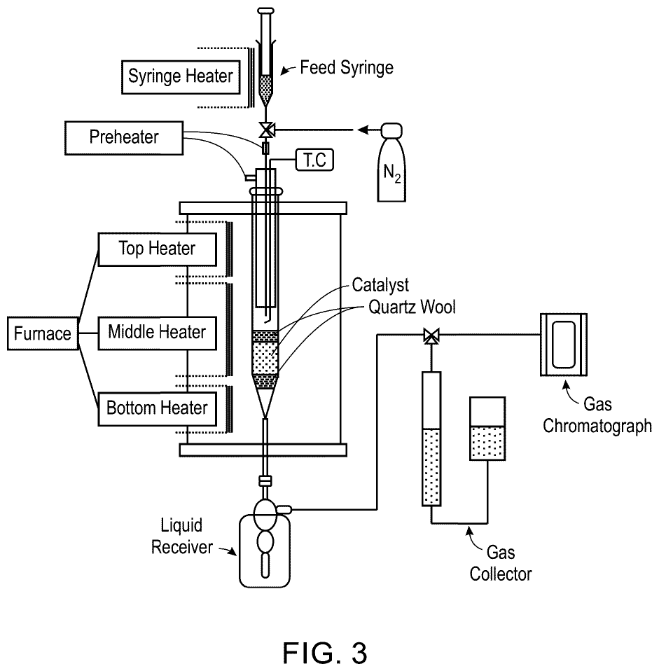

Prepared catalysts were tested for the cracking of VGO into gasoline and butylenes. The reactions were conducted in a micro activity test (MAT) instrument using a quartz tubular reactor as shown in FIG. 3. The synthesized catalysts were evaluated for cracking the feed according to ASTM D-3907 method. All catalysts were steamed at 810° C. for 6 hours prior to the reaction to mimic the equilibrium catalyst in the actual operation. The experiments were conducted in the MAT unit at 30 seconds time-on-stream (TOS), 530° C. and catalyst-to-oil ratio of 7. After each reaction, catalysts were stripped using 30 mL/min N₂ flow. The liquid product was collected in the liquid receiver and the gaseous products were collected in a gas burette by water displacement and sent to the GC for analysis. The spent catalysts were used to measure the amount of generated coke from the reaction.

### Optimization of Weight Composition of Y Zeolite in Total Catalyst Weight

Three catalyst formulations were prepared as described above but with different amounts of Y zeolite (fixed silica-to-alumina ratio (SAR) of 80) to optimize the activity of the catalyst as a function of the amount of Y zeolite. Catalysts with 20 wt. %, 30 wt. %, and 35 wt. % of Y zeolite were prepared (denoted as Y20%, Y30% and Y35%, respectively). As the amount of Y zeolite was varied, the amount of ZSM-5 was altered so that the combined composition of the two zeolites was about 41 wt. % of the total catalyst weight. Without wishing to be bound by theory, it is believed that maintaining the combined amount of ZSM-5 and Y zeolites at around 41 wt. % of the total catalyst weight maintains the mechanical stability of the catalyst.

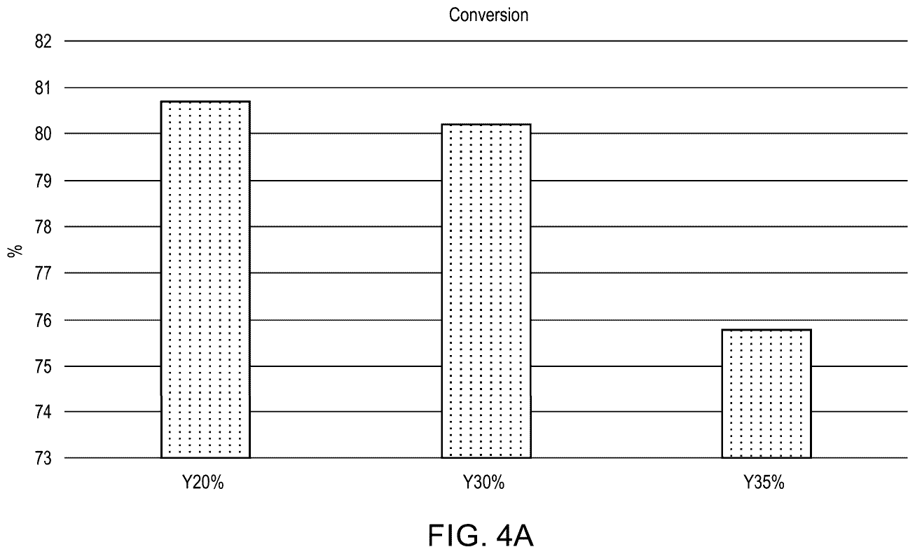

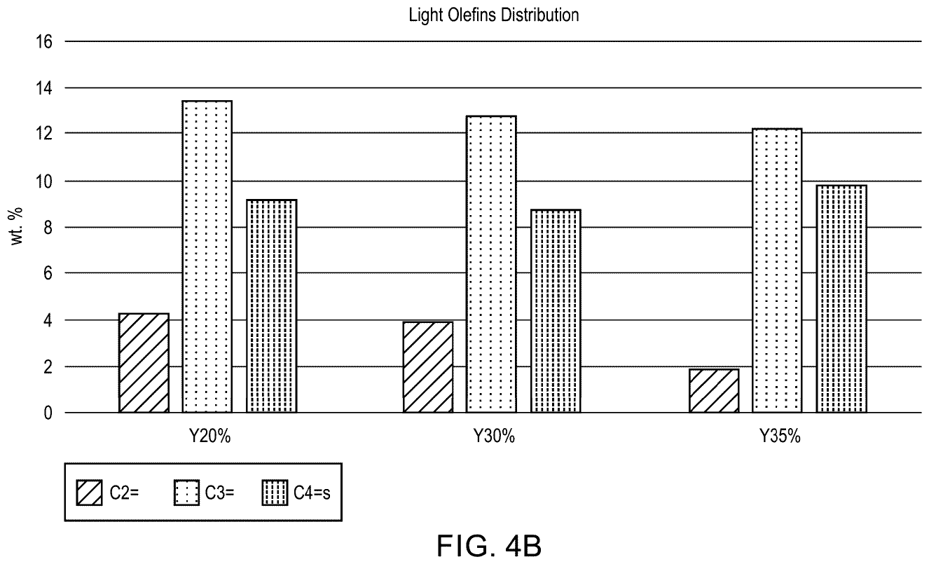

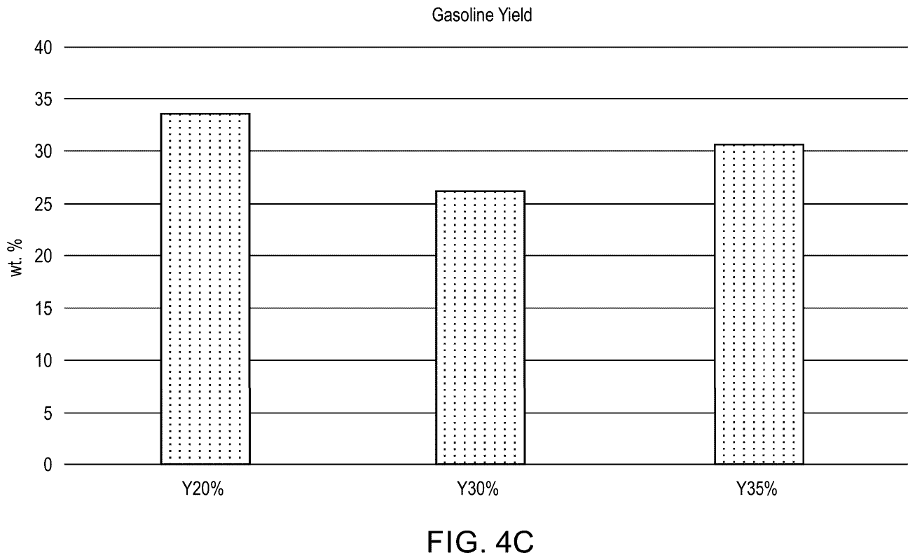

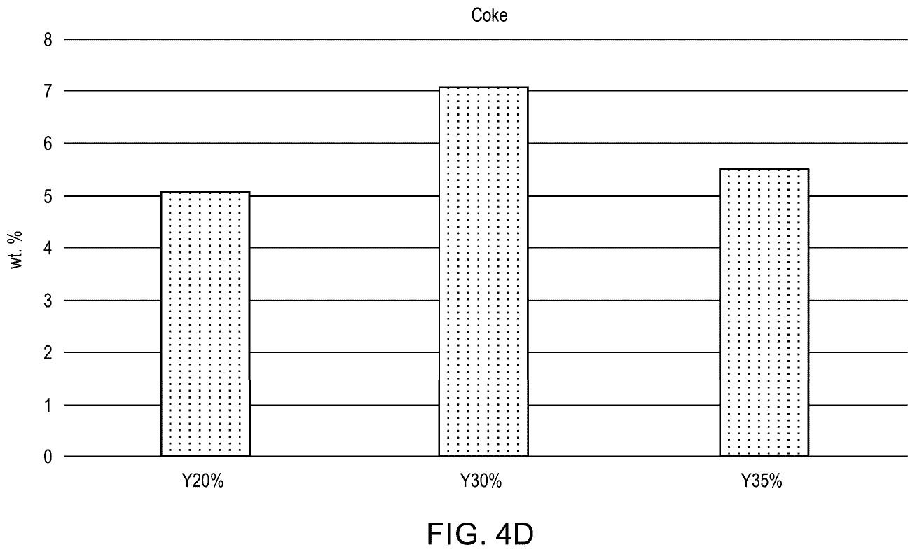

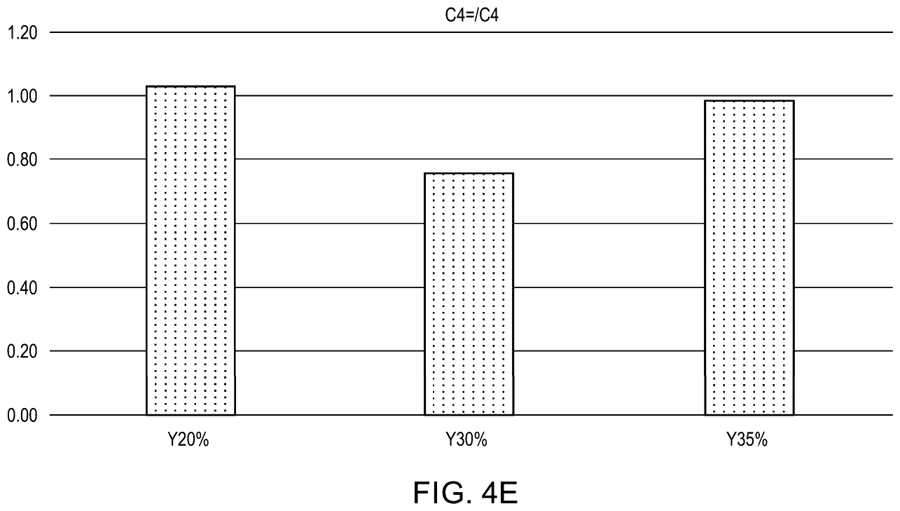

FIGS. 4A-4E show the impact of Y composition on the performance of the catalyst during the cracking reactions. FIG. 4A shows the conversions, FIG. 4B shows the light olefin distributions, FIG. 4C shows the gasoline yields, FIG. 4D shows the coke production, and FIG. 4E shows the butylene to butane ratios for the three prepared catalysts in the cracking of VGO.

Y20% gave the best conversion, gasoline yield and selectivity to butylenes. Moreover, Y20% gave the lowest coke production. Consequently, 20 wt. % of Y zeolite was selected for further optimization studies.

### Optimizing Acidity of Y Zeolite

Using an amount of Y zeolite of 20 wt. %, additional catalysts were synthesized with varying Y zeolite acidity, as shown in Table 5. The SAR was varied by obtaining and using Y zeolites with varying SARs (Zeolyst International Company). FCC5 corresponds to Y20% from the above example.

TABLE 5
SAR of tested catalysts

| Catalyst acronym | SAR |
|---|---|
| FCC1 | 5.2 |
| FCC2 | 12 |
| FCC3 | 30 |
| FCC4 | 60 |
| FCC5 | 80 |

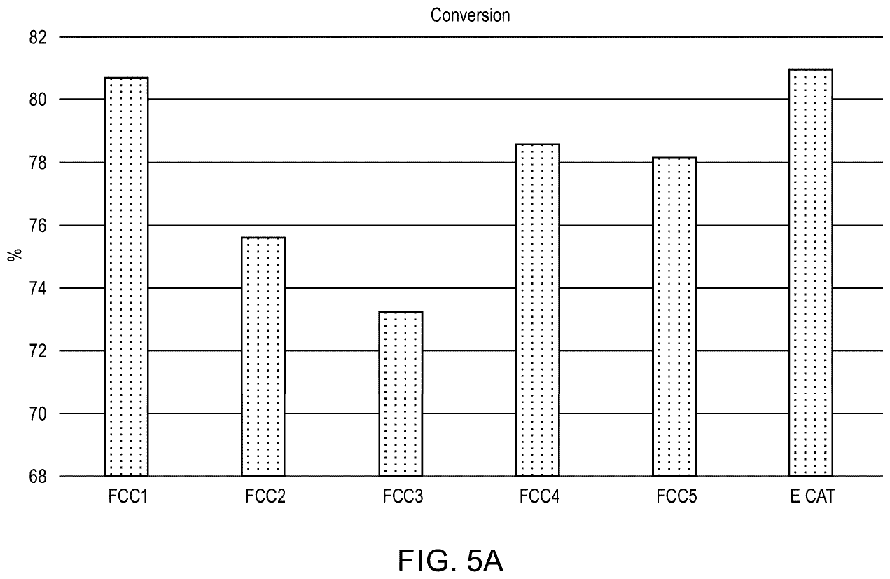

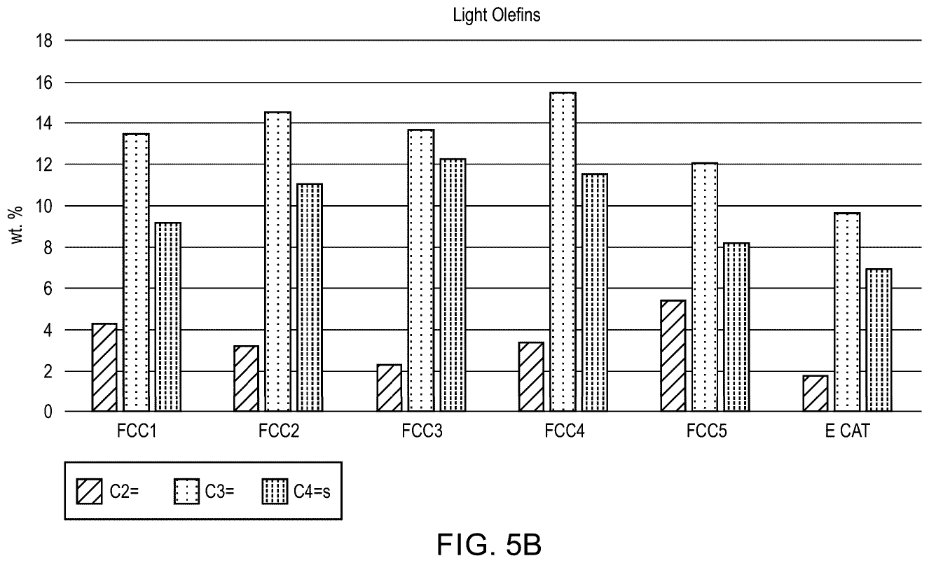

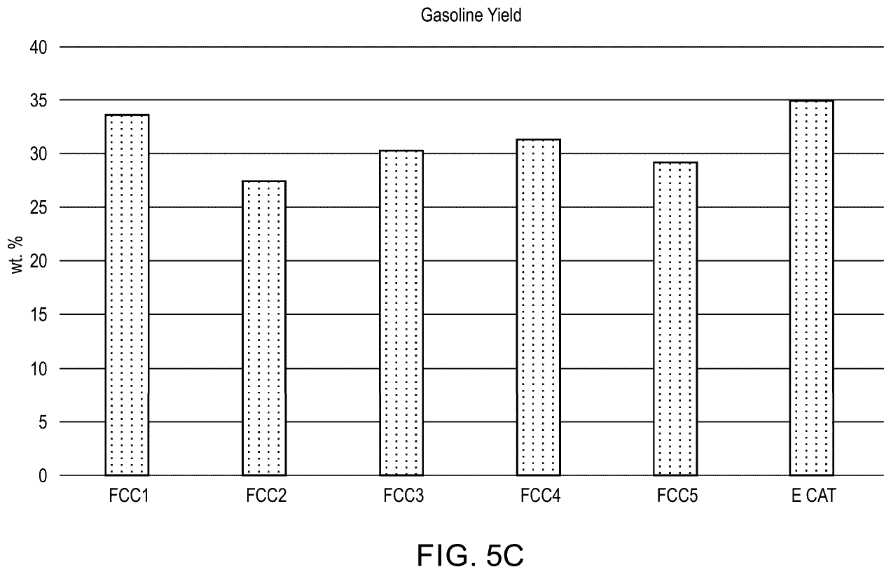

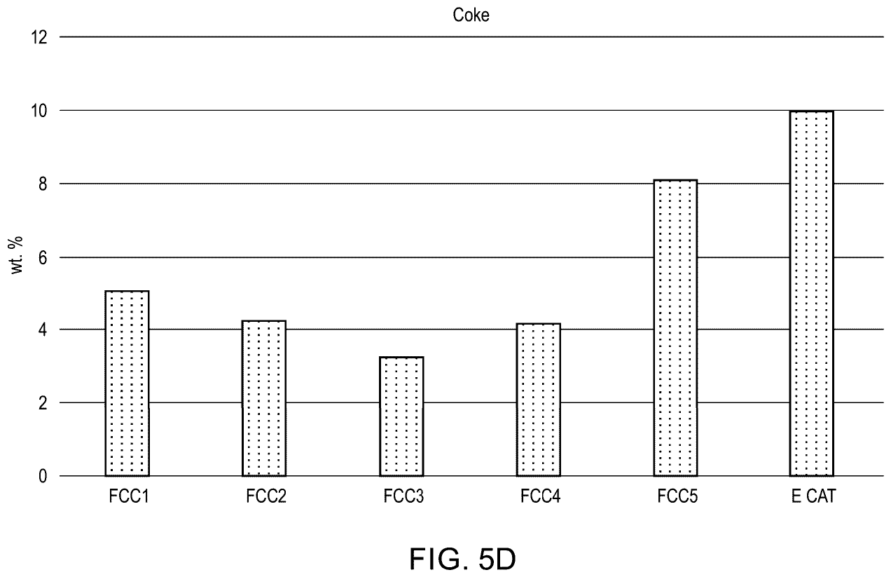

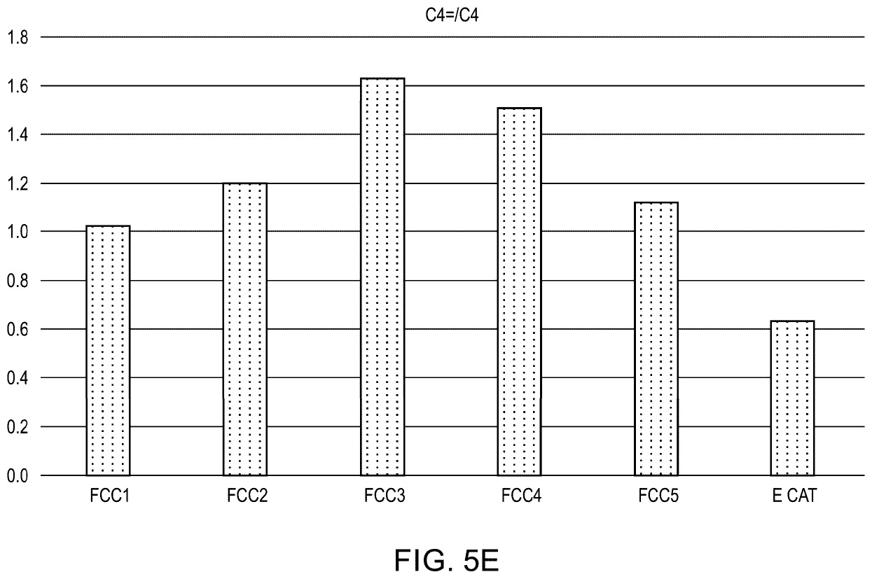

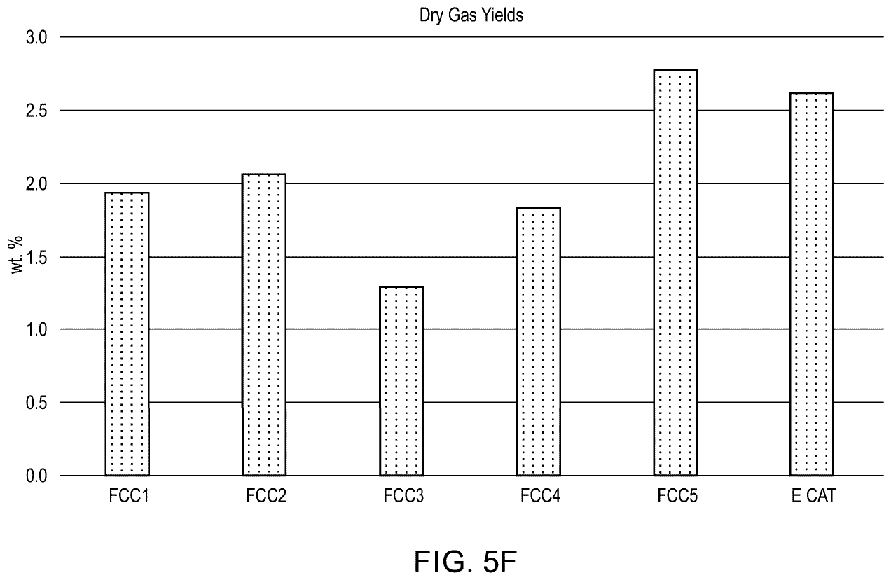

FIGS. 5A-5E show the impact of the SAR on the performance of the catalyst during the cracking reactions. The catalysts of Table 5 were also compared with a commercial cracking catalyst that includes Y zeolite (denoted as E CAT). FIG. 5A shows the conversions, FIG. 5B shows the light olefin distributions, FIG. 5C shows the gasoline yields, FIG. 5D shows the coke production, FIG. 5E shows the butylene to butane ratios, and FIG. 5F shows the dry gas yields for the prepared catalysts and E CAT.

As shown in FIG. 5A, among the synthesized catalysts, FCC1 resulted in the highest conversion of feed followed by FCC4 and FCC5. FCC1 showed comparable conversion with E CAT.

As shown in FIG. 5B, all synthesized catalysts showed higher yields of ethylene, propylene and butylenes than E CAT. Moreover, FIG. 5E shows higher selectivity to butylenes over butanes (expressed as C4=/C4) when compared to E CAT. Without wishing to be bound by theory, it is believed that higher selectivity to butylenes is an indication of a lower hydrogen transfer. Hydrogen transfer is undesirable as it saturates the formed alkenes to their corresponding alkanes. Hydrogen transfer is a function of the density of the acidic sites in the catalyst surface and pores. The synthesized catalysts were mainly tailored for improved conversion levels.

As shown in FIG. 5C, FCC1 showed the highest level of gasoline production amongst the prepared catalysts while producing comparable yield of gasoline with E CAT.

FIG. 5D shows lower coke production for the prepared catalysts compared with E CAT, although this may not be representative of the actual coke production at continuous catalyst circulation at fluidized operation. Without wishing to be bound by theory, it is believed that coke production from the cracking reactions is a result of a complex interlink between feed composition, catalyst composition, and operational conditions. It is also believed that the zeolites' properties and compositions in the synthesized catalysts can be modified to optimize the coke production from the cracking reactions. This is particularly useful for operating the FCC unit under self-heat-balance mode. This lowers supplemental torch oil requirements and light cycle oil (LCO) or heavy cycle oil (HCO) recycles as the incremental LCO can be upgraded to higher valued products such as ultra-low sulfur diesel (ULSD) and naphtha.

As shown in FIG. 5F, the prepared catalysts produced comparable low levels of dry gas yields with E CAT. This demonstrates that the design of the prepared catalysts does not favor over cracking reactions which produce a relatively high level of dry gas at the expense of light olefins including butylenes.

These results demonstrate that the synthesized catalyst formulations showed potential for achieving high conversion levels while maintaining acceptable production of undesirable dry gas. Under the same cracking conditions, the prepared catalysts showed better selectivity to butylenes and lower coke production than E CAT. The best conversions were observed with a Si/Al ratio for the Y zeolite of about 5. As discussed above, the C4=/C4 ratios may be influenced by the cracking temperatures and/or the feedstock.

The prepared catalysts fulfill the comprehensive parameters for an FCC catalyst. Specifically, the synthesized catalyst gave high conversion and high selectivity to gasoline and butylenes. They meet the fluidization specification relating to particle size and shape. They also achieved low attrition index and therefore high endurance to the severe process operation, such as high steam and high temperatures, and mechanical aspects.

### Embodiments

1. A method of cracking vacuum gas oil, including:
   converting at least one component of vacuum gas oil into a product using a catalyst,
   wherein the catalyst includes:
      a first zeolite including a member selected from the group consisting of ZSM-5 and Y zeolite;
      a second zeolite including a member selected from the group consisting of ZSM-5 and Y zeolite;
      wherein:
         the second zeolite is different from the first zeolite;
         the first zeolite is impregnated with P₂O₅; and
         the second zeolite is impregnated with La₂O₃.
2. The method of embodiment 1, wherein the product includes at least one member selected from the group consisting of a butylene and gasoline.
3. The method of embodiment 1 or 2, wherein the vacuum gas oil is not hydrotreated.
4. The method of any one of embodiments 1-3, wherein the converting is performed at a temperature of from 470° C. to 590° C.
5. The method of any one of embodiments 1-3, wherein the converting is performed at a temperature of from 470° C. to 550° C.
6. The method of any one of embodiments 1-5, wherein a conversion of the vacuum gas oil is at least 80%.
7. The method of any one of embodiments 1-6, wherein a yield of gasoline is at least 25%.
8. The method of any one of embodiments 1-7, wherein coke production is less than 9 wt. %.
9. The method of any one of embodiments 1-8, wherein a dry gas yield is less than 3 wt. %.
10. The method of any one of embodiments 1-9, wherein a dry gas yield is less than 2.5 wt. %.
11. The method of any one of embodiments 1-10, wherein a butylene to butane ratio is at least 1.
12. The method of any one of embodiments 1-11, wherein:
   the first zeolite includes ZSM-5, and the second zeolite includes Y zeolite; or
   the first zeolite includes Y zeolite, and the second zeolite includes ZSM-5.
13. The method of any one of embodiments 1-12, wherein the catalyst includes from 10 wt. % to 50 wt. % of the Y zeolite.
14. The method of any one of embodiments 1-13, wherein the catalyst further includes:
   alumina;
   clay; and
   silica.
15. The method of embodiment 14, wherein the catalyst includes:
   from 5 wt. % to 50 wt. % of the first zeolite;
   from 5 wt. % to 50 wt. % of the second zeolite;
      from 0.5 wt. % to 10 wt. % La₂O₃;
   from 0.5 wt. % to 15 wt. % P₂O₅;
   from 0.5 wt. % to 10 wt. % silica;
   from 30 wt. % to 60 wt. % clay; and
   from 2 wt. % to 20 wt. % alumina.
16. The method of embodiment 14, wherein the catalyst includes:
   20 wt. % of ZSM-5 impregnated with P₂O₅;
   21 wt. % of Y zeolite impregnated with La₂O₃;
   2 wt. % silica;
   49 wt. % clay; and
   8 wt. % alumina.
17. The method of embodiment 16, wherein:
   the ZSM-5 impregnated with P₂O₅ includes 7.5 wt. % P₂O₅; and
   the Y zeolite impregnated with La₂O₃ includes 2.5 wt. % La₂O₃.
18. The method of any one of embodiments 1-17, wherein the ZSM-5 has a silica to alumina molar ratio of 5 to 80.
19. The method of any one of embodiments 1-18, wherein the Y zeolite has a silica to alumina molar ratio of 5 to 80.
20. The method of any one of embodiments 1-18, wherein the Y zeolite has a silica to alumina molar ratio of about 5.

What is claimed is:

1. A method of cracking vacuum gas oil, comprising:
converting at least one component of vacuum gas oil into a product using a catalyst,
wherein the catalyst comprises:
a first zeolite comprising a member selected from the group consisting of ZSM-5 and Y zeolite;
a second zeolite comprising a member selected from the group consisting of ZSM-5 and Y zeolite;
wherein:
the second zeolite is different from the first zeolite;
the first zeolite is impregnated with P₂O₅; and
the second zeolite is impregnated with La₂O₃.

2. The method of claim 1, wherein the product comprises at least one member selected from the group consisting of a butylene and gasoline.

3. The method of claim 1, wherein the vacuum gas oil is not hydrotreated.

4. The method of claim 1, wherein the converting is performed at a temperature of from 470° C. to 590° C.

5. The method of claim 1, wherein the converting is performed at a temperature of from 470° C. to 550° C.

6. The method of claim 1, wherein a conversion of the vacuum gas oil is at least 80%.

7. The method of claim 1, wherein a yield of gasoline is at least 25%.

8. The method of claim 1, wherein coke production is less than 9 wt. %.

9. The method of claim 1, wherein a dry gas yield is less than 3 wt. %.

10. The method of claim 1, wherein a dry gas yield is less than 2.5 wt. %.

11. The method of claim 1, wherein a butylene to butane ratio is at least 1.

12. The method of claim 1, wherein:
the first zeolite comprises ZSM-5, and the second zeolite comprises Y zeolite; or
the first zeolite comprises Y zeolite, and the second zeolite comprises ZSM-5.

13. The method of claim 1, wherein the catalyst comprises from 10 wt. % to 50 wt. % of the Y zeolite.

14. The method of claim 1, wherein the catalyst further comprises:
alumina;
clay; and
silica.

15. The method of claim 14, wherein the catalyst comprises:
from 5 wt. % to 50 wt. % of the first zeolite;
from 5 wt. % to 50 wt. % of the second zeolite;
from 0.5 wt. % to 10 wt. % La₂O₃;
from 0.5 wt. % to 15 wt. % P₂O₅;
from 0.5 wt. % to 10 wt. % silica;
from 30 wt. % to 60 wt. % clay; and
from 2 wt. % to 20 wt. % alumina.

16. The method of claim 14, wherein the catalyst comprises:
20 wt. % of ZSM-5 impregnated with P₂O₅;
21 wt. % of Y zeolite impregnated with La₂O₃;
2 wt. % silica;
49 wt. % clay; and
8 wt. % alumina.

17. The method of claim 16, wherein:
the ZSM-5 impregnated with P₂O₅ comprises 7.5 wt. % P₂O₅; and
the Y zeolite impregnated with La₂O₃ comprises 2.5 wt. % La₂O₃.

18. The method of claim 1, wherein the ZSM-5 has a silica to alumina molar ratio of 5 to 80.

19. The method of claim 1, wherein the Y zeolite has a silica to alumina molar ratio of 5 to 80.

20. The method of claim 1, wherein the Y zeolite has a silica to alumina molar ratio of about 5.
